(19) United States
(12) Patent Application Publication
(10) Pub. No.: US 2019/0106246 A1
(43) Pub. Date: Apr. 11, 2019

(54) CLOSURE WITH RETENTION RING AND HINGE

(71) Applicant: John Kirby Kendall, Cedar Park, TX (US)

(72) Inventor: John Kirby Kendall, Cedar Park, TX (US)

(73) Assignee: Kendall Innovation Group, Cedar Park, TX (US)

(21) Appl. No.: 16/154,751

(22) Filed: Oct. 9, 2018

Related U.S. Application Data
(60) Provisional application No. 62/569,639, filed on Oct. 9, 2017.

(51) Int. Cl. B65D 41/34; B29C 45/00

(52) U.S. Cl. CPC B65D 41/3428; B29K 2023/12; B29C 45/0081

(57) ABSTRACT

The present invention relates to a new closure for a container, the manufacturing precursor that is converted into the closure, and the method of closure manufacture. The closure is comprised of a cap (usually threaded), a retention ring (that keeps the closure assembly connected to the container), and a hinge and articulating band that connects the cap to the retention ring. The closure is made by three major steps in the method: (1) polymer molding the closure, (2) scoring/cutting the closure, and (3) stamping the hinge which reorients the polymer. The hinge and articulating band elements are manufactured so that the band articulates and changes shape as the closure is opened. By necessity, the cap and the retention ring must separate as the cap is lifted or unthreaded; the articulating nature of the hinge and band feature allows it to keep the cap and retention ring connected as they separate. Even after opening the container, the cap remains attached to the container for convenience and anti-littering purposes.

### DESCRIPTION

The present application claims priority from U.S. Provisional Patent Application Ser. No. 62/569,639; filed 9 Oct. 2017. The content of the above-identified patent application is hereby incorporated by reference herein in its entirety.

### FIELD OF THE INVENTION

The present invention generally relates to a closure for a container, the manufacturing precursor that is converted into the closure, and the method of closure manufacture. These closures are used as caps for soda drinks, bottled water, sports drinks, food sauces, creams, ointments, and household formulations among other uses. The closure is comprised of the following elements: a cap (usually threaded), a retention ring (that keeps the closure assembly connected to the container), and a hinge and articulating band that connects the cap to the retention ring. There may also be other elements such as security tabs and engaging catches.

The method comprises the major steps of polymer molding the closure, scoring/cutting the closure, and stamping the hinge which reorients the polymer. The molding step creates the body of the polymer closure, and other structures that are co-molded as part of the cap, including hinge precursor material. These other structures may include components such as threads, retaining ring tab precursors, and retaining ring catches. A scoring step after molding creates the retention ring, the hinge feature, and the articulating band. The scoring step uses conventional circumferential cutting where the blade cuts to a constant depth around the whole of the closure. There is a stamping step that further modifies the closure. This stamping flattens, shapes, and reorients the polymer of the hinge precursor material into a flat, butterfly, or other hinge.

The hinge and articulating band feature are manufactured so that the feature articulates and changes shape as the closure is opened. By necessity, the cap and the retention ring must separate as the cap is lifted or unthreaded; the articulating nature of the hinge and band feature allows it to keep the cap and retention ring connected as they separate. Even after opening the container, the cap remains attached to the container for convenience and anti-littering purposes.

### BACKGROUND OF THE INVENTION

There are two general methods in the art to manufacture a hinge for a closure: (1) the hinge is created during the molding process, possibly with a post-mold modification step such as stamping/coining; or (2) the hinge is created from two pieces that are molded separately and are assembled together in order to create the hinge. The latter type, (2), of assembling two separate pieces allows for a great deal of flexibility when designing a hinge, but the two separate parts require a step where they are assembled into the closure. These two-part closures are not discussed further.

For closures of production method (1), the closure is usually molded in the open position wherein the upper and lower sections of the hinge are molded in adjacent cavities with the hinging element being simultaneously molded as a connection between the two sections. Typically, the function of the lower section is to remain attached to the container while the upper section opens to reveal the contents. The main disadvantage of this open-molded closure is that such closures require twice as much mold space as simple un-hinged closures and are therefore slower and/or more expensive to produce. Also, such open-molded closures also cannot be manufactured using faster, and lower cost compression molding methods such as compression molding. The purpose of this invention is to produce an improved closure with a hinge that is created in the closed state.

Beverage bottle such as PET soda drinks or bottled water have a twist-off closure that is molded by lower-cost compression molding methods. Additionally, these closures possess a lower ring, with a number of catches that latch onto the neck of the bottle. The precursor to the ring and catches are manufactured during the closure molding process. A cutting process then turns the ring precursor into the ring. Precursors to frangible tabs are also molded into the closure. A circular knife or other instrument in the above-mentioned cutting process also converts the tab precursors into the frangible tabs (e.g. U.S. Pat. No. 4,418,828). The frangible tabs provide tamper-resistant indication for the sealed bottle. One major drawback of the conventional soda and water twist-off closure is that the upper cap portion is not hinged or tethered and can be easily lost or become litter.

There is some previous art that describes a closure that is both made in a close-molded fashion and hinges to open the closure. U.S. Pat. Nos. 4,109,814, 4,919,286, and similar patents however only possess simple hinges that do not articulate. That is, the hinge cannot change geometry so that it can be attached to both (1) the lower/retention portion of the closure that stays in a fixed location on the closure, and (2) the upper/sealing portion of the closure that must lift vertically (e.g., over a threaded portion of the closure) before it can begin to swing open.

Other patents (e.g. U.S. Pat. Nos. 4,394,918 and 5,215,204) describe units that provide some ability to articulate. However, these closures do not possess a discontinuous retention ring (i.e. incompletely circumferential); and therefore do not possess a hinge that extends though the ring's absent region to the articulating band. Similarly, a cap was illustrated in Packaging Digest that also used articulating arms to allow the cap to lift away from the retention ring as the cap is unscrewed by the user. However, details on this closure and its production method were not provided.

### SUMMARY OF THE INVENTION

The purpose of this invention is to produce an improve closure that work with little modification to production equipment that can be used for processing inexpensive closures. Different approaches to close design and processes are described to achieve this purpose. The invention is closure precursor, a closure, and closure manufacturing process to create a hinge and articulating band feature. Distinct steps are required to make the desired closure; therefore, the term “precursor” is used to distinguish between a closure component that is not yet in final form, versus the component that is more complete. The first step in manufacturing is making the precursor by a molding process, preferably compression molding, that creates the closure comprising the cap portion, retention ring precursor, frangible tabs precursor, hinge precursor, articulating band precursor, and optionally ring catches. Other optional and preferential components that may comprise the closure including threads, hand grip ribbing, and sealing means.

Two major molding processes for closures are injection molding and compression molding. This invention can utilize either of these processes or other molding processes. But for economy reasons compression molding is typically preferred.

A subsequent step in the manufacturing process is a scoring of the molded closure. The cutting/scoring step converts some of the precursors into their final form. In one embodiment, creating the score involves a blade cutting the closure completely (360 degrees) around its circumference. The scoring process cuts through the material of the closure creating the retention ring from its precursor. Also, the scoring is controlled to a radial depth so that while it cuts through the material, it does not cut so deep as to cut completely through the frangible tabs polymer or the hinge polymer. Thus the spaced tab precursors become the frangible tabs upon scoring. In a similar fashion, the scoring cuts through material that comprises the articulating band precursor, turning it into the articulating band. The same scoring depth control that creates the tabs also creates the hinge connection point between the cap and the hinge. The ability to control the scoring depth is well known in the art.

Since the articulating band is on the exterior of the retaining ring (the band possessing a larger radius of curvature than the ring), and the connection point between the cap and hinge is on the interior of the closure, the hinge must pass through the retention ring. One method to create this absent region of the ring is to add a step in the manufacturing process that removes retention ring material. This extra step is not preferred. Rather, the preferred production project creates the absent region of the retention ring as part of the molding process.

### BRIEF DESCRIPTION OF THE DRAWING

The invention will be better understood with reference to the accompanying figures, representing, by way of non-limiting example, an embodiment of the produced closure.

FIG. 1 is an isometric view of a closure precursor.

FIG. 2 is an underside view of a closure precursor.

FIG. 3 is another underside view of a closure precursor.

FIG. 4 is an isometric view a scored closure.

FIG. 5 is an exterior close-up view of a score.

FIG. 6 is an interior close-up view before adding a score.

FIG. 7 is an interior close-up view after adding a score.

FIG. 8 is an isometric view of closure precursor.

FIG. 9 is an underside view of a closure precursor.

FIG. 10 is an interior close-up view of a hinge precursor.

FIG. 11 is an interior close-up view after scoring.

FIG. 12 is an isometric view of the closure.

FIG. 13 is an interior view of the closure.

### DETAILED DESCRIPTION OF THE INVENTION

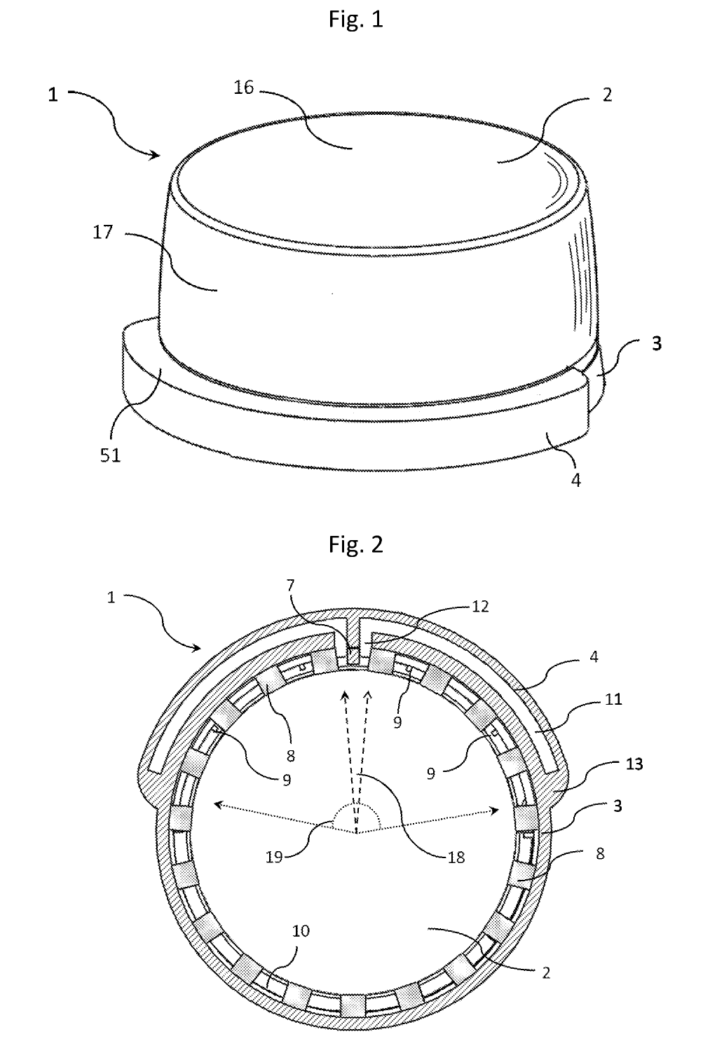

FIG. 1 shows what appears to be a conventional-type beverage cap with some modification. Closure precursor 1 is presented in the state as it exits the polymer molding process. The scoring (cutting) step has not yet occurred. Many thermoplastics or thermosets could comprise the material of construction of 1. The preferred material is polypropylene since it the most widely used material for most closures in the marketplace. For the sake of clarity, the closed end of the cap 16 is referenced in the upper end of 1. Ring precursor 3 is noted as being at the lower end of 1. The inner portion of 1 is sometimes referenced (i.e. towards the cavity), as is the outer direction (i.e. in the direction from the cavity through the wall).

Cap precursor 2 is the part of closure precursor 1 that will become cap 32 with additional processing steps, and is illustrated without optional features. Some of these features include ribbing or designs that improve the user's grip of the closure. A logo or name is another optional feature. Cap precursor 2, or the final cap 32, may also possess features on its interior surface that aid in sealing the container. Such optional features include a circular rib that seals on the inside of the container's lip, and a layer of material that seals against said lip with less pressure. These features are well known in the industry. Cap precursor 2, since it will become a cap, naturally possess a closed end 16 and walls of the cap 17.

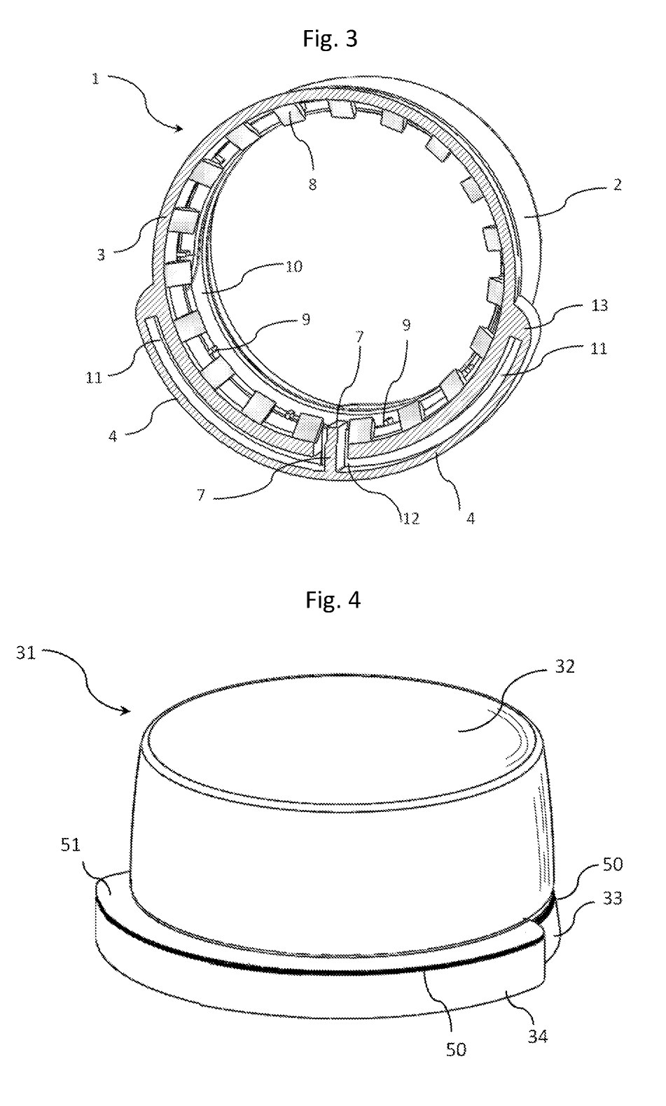

Semi-annular (incompletely circumferential) ring precursor 3 extends down below 17. The discontinuous nature of 3 can be seen in FIGS. 2 and 3. There is an absent region, noted as element 12, where it can be seen that 3 does not complete a full circle and thus does not cover all 360 degrees of the closure. Hinge precursor 7 resides within gap 12. The required passage of 7, from the interior of the cap to the exterior, is the reason for 12 being present. In addition to being connected to 2, 3 is also integrally molded to the two ends of articulating band precursor 4. Connection points 13 between 3 and 4 are on each side of 7 as shown in the figures. Note the gap or spacing between 3 and 4 is denoted by 11 in FIG. 2.

The two connection points 13 may be made at different points and are defined by subtending angle 19. 19 may reasonably cover the range from 20 to 200 degrees. In prototype testing the angle 19 was usually limited to 120 to 180 degrees.

The width of 7 and 12 are variable and are determined by a number of factors including processing equipment, material of construction, wall thicknesses, bottle design, and visual appearance. 12 is defined by a subtending angle 18 as seen in FIG. 2. Note that the larger 18 (and 12) becomes, the smaller circumferentially 3 becomes. The angle that 18 may cover is very large in range—from 5 to 120 degrees. In prototype testing, the angle 18 generally fell between 10 and 45 degrees.

Precursor 4 is attached to the rest of the closure at points 13. Proximate to the centerpoint, 4 is comprised of another element: hinge precursor 7. Optionally, 4 may be also attached to 2 as shown in FIG. 1 by bridge 51. The advantage of having 4 connected to 2 is due to ease of manufacturing. Since the creation of 1 in a molding process relies on polymer flow, the molding speed is improved if the fluid material that is comprising 2 can overflow to become the fluid material that comprises 4. This mass of material connecting 2 to 4 is bridge 51. After the scoring step, the thickness of 51 is variable based on how the cutting is performed. If the score/cut is performed at an angle relative to the top plane of the closure, then 51 will have a varied appearance and connection to 2 and 4, if it is not removed by the scoring process.

The shape and thickness of 4 is important to the function of the cap. Arms 4 must twist as the cap is flipped into the open position. The function of 4 is dependent in-part on the polymer chemistry, polymer properties, thickness, and height. From testing, it is preferred that the cross section of 4 be a square cross section, which was found to perform better than a 2:1 ratio rectangular cross section. However, this testing was performed with nylon, and the preferred polymer, polypropylene, may require different cross section.

After the molding step, the scoring step can proceed. The method by which the closure is scored/cut affects its design and function. The method is an even-depth cut that is standard in the industry. The full, circumferential score is made to and even depth (i.e. a set radial distance into the closure around all 360 degrees of the closure, generally to a depth that makes the security tabs 39 from 9.

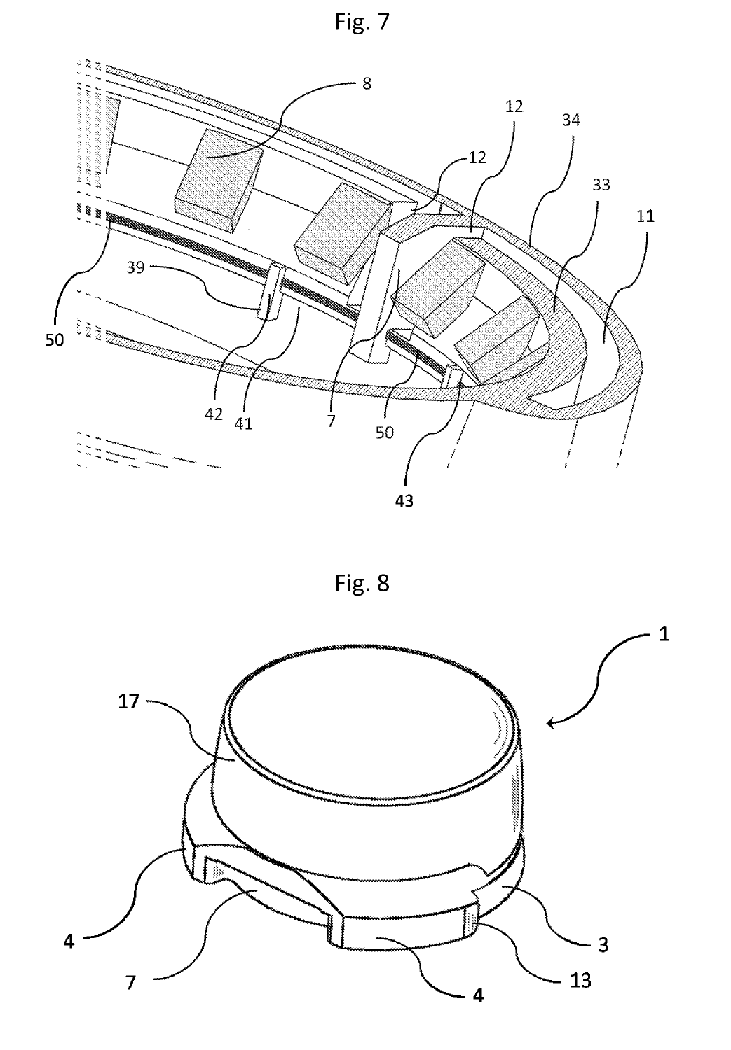

In FIGS. 2 and 3 the hinge precursor 7 can be seen. While not clear from the image, some of the mass of material of 7 lies within the radius of 2. FIG. 7 better illustrates these distances. The interior radial distance of the tab precursor 9 (and thus the tab 39) is marked as 42. The interior radial distance of the wall is marked as 41. And the interior radial distance of the score is marked as 43. 42, and the unmarked radial distance of the hinge precursor 7, are closer to the origin and have smaller distances. 43 only needs to be slightly less than 41 in order to cut through wall 17. Thus, when a cutting blade turns the precursors into their final form, not all of 7 is cut. That is, some of 7 is beyond the depth of the scoring tool. The radial distance of 7 depends on the type of polymer that is used to make 1, and the exact nature of how the polymer flows during the molding process. Addressed further below, 7 is modified by a stamping step.

Gap 12 causes the discontinuity of 3. 12 is on both sides of 7 since 7 must pass through gap 12 in order to make its proper connections after the cutting step occurs and 7 becomes 37. Space 11 is also present to separate the material of 3 and 4. 11 will also become exposed on the upper end after the cutting step that makes final closure 31.

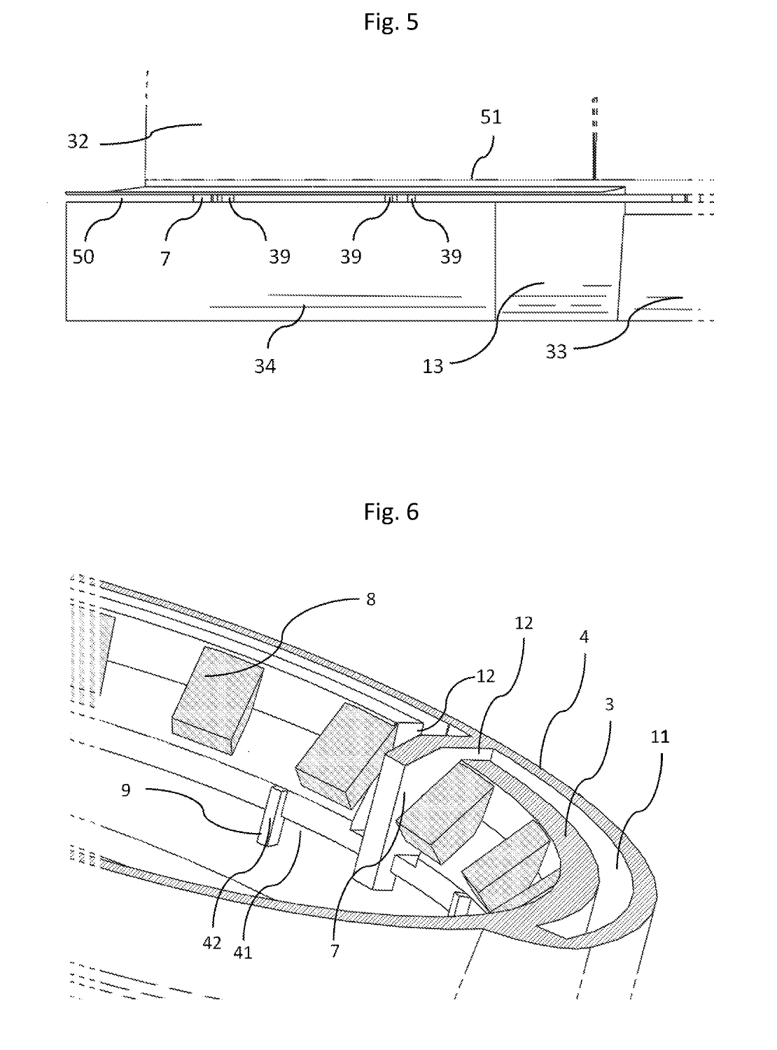

The scoring (or cutting) step adds a score to closure precursor 1. This change may be best seen by comparing FIG. 1 to FIG. 4, and by comparing FIG. 6 to FIG. 7. A close-up of the score can be readily seen in FIG. 5. A number of other features are created when the score is added. For example, the single circumferential cut 50, which is well known in the art, converts 3 into 33, 4 into 34, and 9 into 39.

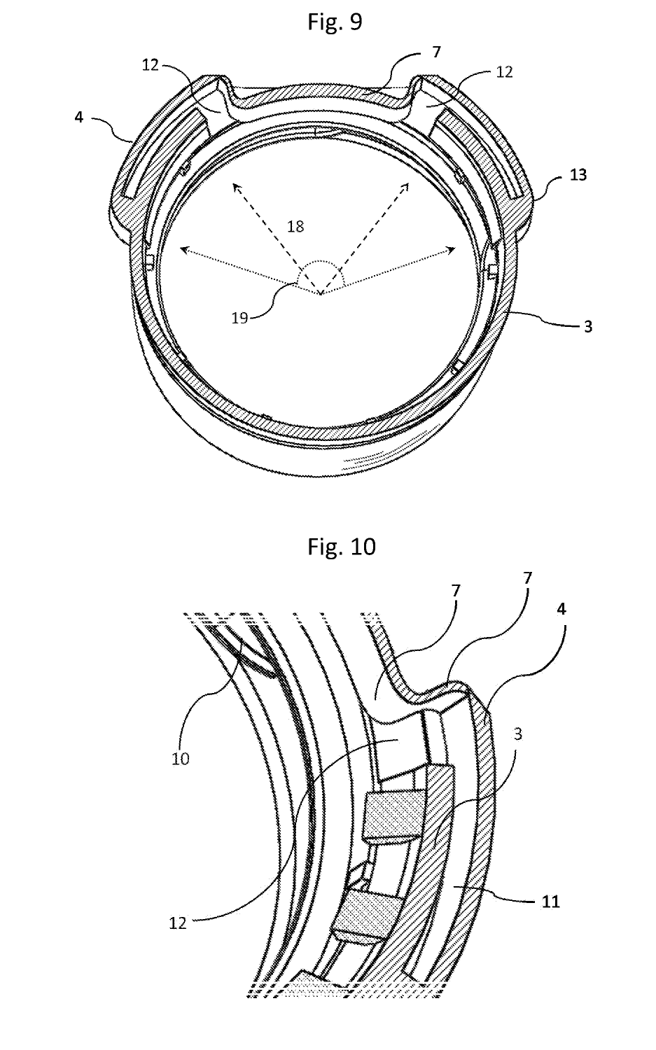

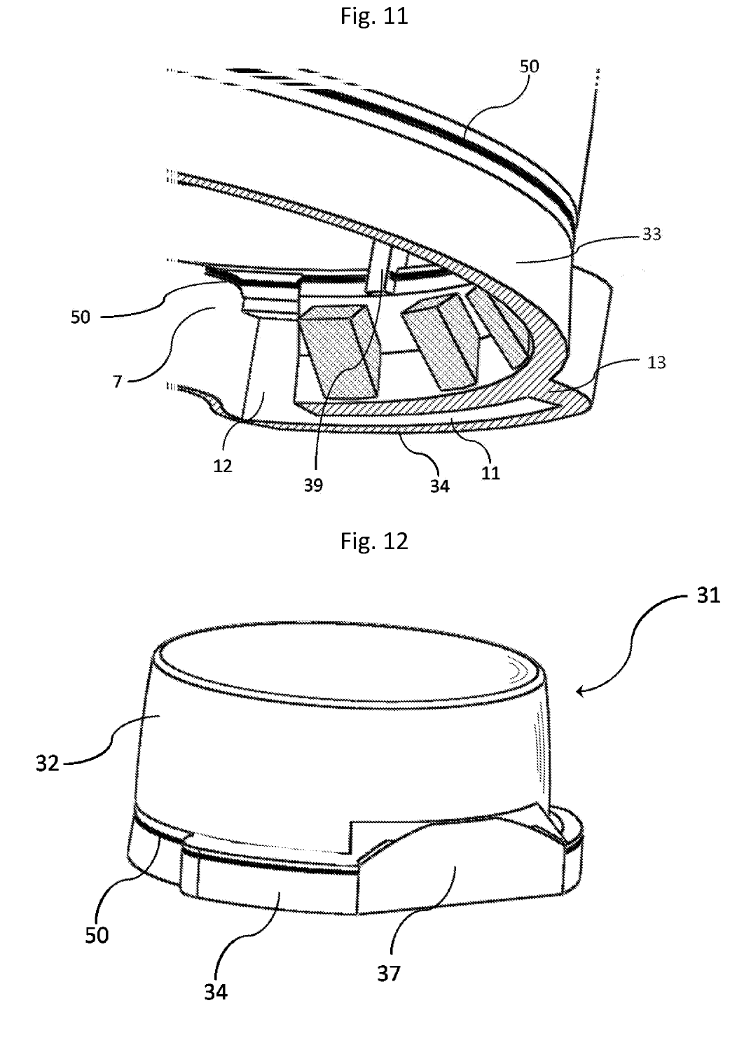

FIGS. 8, 9, 10, and 11 demonstrate a broader version of hinge precursor 7 than the earlier figures. FIG. 9 specifically demonstrates different subtending angles 18 and 19 than those in FIG. 2. Both of these closure precursors were prototyped and successfully made into closures. FIG. 10 is a close-up demonstration of how hinge precursor 7 curves back into and through the absent section 12. Note specifically in FIG. 11 how score 50 does not cut all the way through hinge precursor 7. 50 is represented by the dark ring, but it only scores a fraction of frangible tab 39 and hinge precursor 7.

FIG. 12 illustrates the final closure 31 ready for installation onto a bottle. Score 50 is present so that the cap 32 can lift. Since 32 is connected to hinge 37, and 37 is part of arms 34, and arms 34 are connected to the security ring 33, the cap stays attached to the bottle. Note how 37 in this demonstration is flat. Thus the stamping process used to make 37 reorients the polymer of 37. This reorientation of the polymer stretches the polymer chains and makes them longer. These longer chains act as reinforcement in the hinge. Thus the reoriented polymer made by stamping is stronger than the as-molded polymer. Since the polymer is stronger is can be made thinner and possess snap-lock features to hold the cap on the open position.

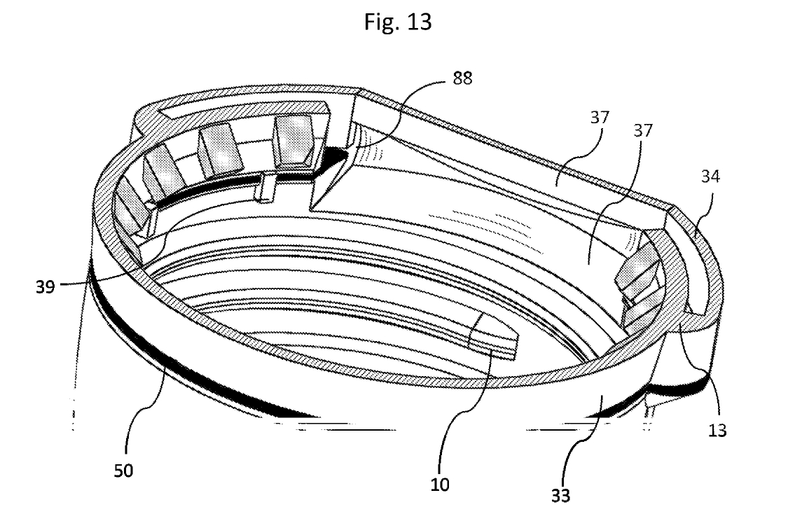

FIG. 13 demonstrates an interior view of the final closure 31. Hinge 37 has been thinned and pressed outward by the stamping process, making is stronger by reorienting the polymer that made up hinge precursor 7. If desired, the stamping process may also cut or notch in and around hinge 37. Note in FIG. 13, that cut 38 was made simultaneous to the stamping process where the stamping tool nicked a portion free at the edges of hinge 37, thus making the operation of 37 smoother to the user.

Inwardly extending catches 8 are well-known in the art. Optional, but preferred, 8 can consist on many different forms. The purpose of 8 is to catch on a ring of material that extends from the container, thus keeping discontinuous ring 33 connected to the container. Depending on the style and nature of catches 8, they may require an additional step in the closure production process. 8 may also be created/modified by a cutting step that is known elsewhere in the art.

Frangible tabs precursor 9 are molded from the same mass of material that makes 2 and 3. 9, and its final form 39, are optional but preferred. 39 generally adds a security element to the closure of indicating tampering. 9, similar to 7, have material of a smaller radius than the wall of 2, and thus are not fully cut by the scoring tool. The cut separates 2 from 3, turning 9 into frangible tabs 39.

Threads 10 are option but preferred. They, in most situations when the container is a beverage bottle, secure closure 31 to the container. The function, use, and production of threads are well known in the art.

It is important that cut 50 fall into the zone of gap 11, below the bottom face of bridge 51, if present. If the cut is made above 11, then the articulating band 34 is still connected to the cap by portions of 51 and thus it cannot function properly.

When the closure is complete, after 32 is unthreaded from the container, it is flipped away from the mouth of the container. During this opening process, hinge 37 and articulating band 34 flex. During the unthreading process to open the container, 32 lifts away from the mouth of the container while ring 33 is held in place by the container. 34 articulates so that 32 and 33 can separate, but stay attached to each other through 34 and 37.

A note should be made about the nature of cut versus uncut material that is stamped or coined. When plastics such as polypropylene are cut, it is very difficult to rejoin the seam by melting and/or pressure. To make a strong rejoined seam, the polymer chains from the two halves must flow and entangle, which is energy intensive and slow. This fact is the reason why the scoring process if important to control in the embodied hinge. If 7 was fully cut through, then any resulting hinge would be weak after being rejoined by stamping. However, since 7 is beyond the reach of the scoring tool, it is never cut through, therefore it's polymer chains remain strong, and on strengthen further after reorientation by stamping.

We claim:

1. A molded polymer closure comprising:
a cap with an upper closed end and an approximately cylindrical wall;
a ring below the wall that is separated from the wall by a score;
a plurality of frangible tabs that are integrally molded to the closure interior such that they conjoin the wall and the ring, and are internal to the score;
an absent section in the ring such that the ring is incompletely circumferential; and
an articulating band with two ends that are integrally molded to the ring such that the articulating band bridges the absent section and is exterior to the ring;
wherein the approximately center of the articulating band comprises a hinge that extends through the absent section to conjoin the articulating band and the wall.

2. A molded polymer closure of claim 1 wherein the hinge is integrally molded to the wall and the articulating band.

3. A molded polymer closure of claim 1 wherein the hinge is comprised of reoriented polymer.

4. A molded polymer closure of claim 1 wherein the hinge was created by stamping, reorienting the polymer of, and strengthening a hinge precursor that was integrally molded to the to the closure interior internal to the score.

5. A molded polymer closure of claim 1 further comprising inwardly extending catches on the ring that engage with a container.

6. A molded polymer closure of claim 1 wherein the internal radial distance of the wall is IRwall, the internal radial distance of the frangible tabs is IRtabs, and the internal radial distance of the score is between IRwall and IRtabs.

7. A molded polymer closure of claim 1 wherein the absent region of the ring traverses a radial span with a subtending angle between 5 to 120 degrees.

8. A molded polymer closure of claim 1 wherein the ends of the articulating band traverse a radial span with a subtending angle between 20 to 200 degrees.

9. A molded polymer closure precursor comprising:
a cap precursor with an upper closed end and a wall;
a ring precursor that is a lower extension of the wall;
a plurality of frangible tabs precursors that are integrally molded to the interior of the closure such that they conjoin the cap precursor and the ring precursor;
an absent section in the ring precursor such that the ring precursor is incompletely circumferential; and
an articulating band precursor with two ends that are integrally molded to the ring precursor such that the articulating band precursor bridges the absent section;
wherein the approximately center of the articulating band precursor comprises a hinge precursor that extends through the absent section and is integrally molded to the interior of the closure.

10. A molded polymer closure precursor of claim 9 wherein the internal radial distance of the wall is IRwall, the internal radial distance of the frangible tab precursors is IRtabs, the internal radial distance of the hinge precursor is IRhinge, and the internal radial distance of IRtabs and IRhinge and is less than IRwall.

11. A manufacturing method of a polymer closure, comprising the steps of:
molding integrally a cap precursor with an upper closed end and a wall, a ring precursor as a lower extension of the wall that is incompletely circumferential due to an absent section, and an articulating band precursor with two ends that are each conjoined to the ring precursor such that the articulating band precursor bridges the absent section of the ring precursor, wherein the approximately center of the articulating band comprises a hinge precursor that extends inward through the absent section of the ring precursor and is conjoined to the interior of the wall;
scoring the exterior of the closure precursor to a radial distance that cuts through the wall to the interior of the closure, precludes cutting through the hinge precursor; and
stamping the hinge precursor to create a reoriented polymer hinge that extends through the absent section of the ring to conjoin the articulating band and the cap.
